(19) United States
(12) Patent Application Publication
(10) Pub. No.: US 2006/0188054 A1
(43) Pub. Date: Aug. 24, 2006

(54) Methods for transporting and canistering nuclear spent fuel

(75) Inventor: Charles W. Pennington, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: NAC International, Inc.

(21) Appl. No.: 11/051,726

(22) Filed: Feb. 4, 2005

(51) Int. Cl. G21C 19/00

(52) U.S. Cl. 376/272

(57) ABSTRACT

Disclosed are methods for transporting and canistering nuclear spent fuel. In one embodiment, the method for transporting and canistering nuclear spent fuel comprises providing a canister that includes a mechanical closure for a lid on a container. The canister containing the nuclear spent fuel is loaded into a transport cask, and the transport cask is sealed at the power plant. It is preferred that the lid is not installed on the canister at the power plant. The transport cask containing the canister and nuclear spent fuel is transported to a remote facility. At the remote facility, the transport cask is opened and the lid of the canister is installed using the mechanical closure to seal the canister after the canister is transported to the remote facility. The canister containing the spent nuclear fuel is placed into an overpack, which is stored at the remote facility.

### FIELD OF THE INVENTION

The present invention relates to methods for transporting and canistering nuclear spent fuel.

### BACKGROUND OF THE INVENTION

The removal of spent nuclear fuel (SNF) from nuclear power plants and the transport of that spent fuel to an away-from-reactor facility for storage, disposal, or further aging (to reduce its heat content through radioactive decay) is a consideration within the nuclear fuel cycle in the U.S. Currently, the operation of a repository for spent fuel includes the transport of the spent fuel to the repository facility where the fuel is then removed from a cask and placed into a waste package for disposal or, alternatively, placed into a sealed canister for storage in a protective, passively cooled overpack for an additional period. This permits the heat content of the fuel to decrease through radioactive decay until the fuel is cool enough to be placed into a waste package for disposal. This latter process is called “waste aging.”

Typically, spent fuel is shipped from a nuclear power plant to a remote facility (repository or storage facility) in one of two configurations: as “bare” fuel, where individual fuel assemblies are placed into discreet locations within a transport cask (a “basket” structure) for later removal individually at the remote facility; or as “canistered” fuel, in which multiple assemblies are placed into a canister having an internal basket structure and welded closures, then shipped in the transport cask without a basket (the canister provides the same functions as the basket). If there is a preference for shipping the fuel in a “bare” configuration, then, at the remote facility, the fuel designated for aging must be removed from the transport cask, placed into a canister, sealed, and placed into a protective, passively cooled overpack. These canister closures are typically welded for the purpose of sealing.

The drawbacks of this approach are that the welding of the canisters at the repository includes the acquisition of costly welding equipment, along with special inspection and testing equipment. It also includes a special area designated for such operations. The welding further includes extensive time and personnel, making it costly and extending operations schedules. The welding process results in more personnel radiation exposure than other sealing methods. The waste aging canisters will need to be opened at some future date for spent fuel disposal; this will include the cutting of the welds on the closure lids and the disposal of the canister system as low-level waste after it is emptied.

Another approach is to ship the bare fuel to the remote facility in what are termed “dual purpose” casks, which are casks that are certified for both the storage and transport of the spent fuel contained therein. Dual purpose casks are very expensive, having design features for both storage and transport, and the licensing activities to certify the design for both storage and transport add to the cost of each system, as well. If the bare fuel is shipped to the remote facility in dual purpose casks, these casks can be taken from the transportation system and placed into storage at a spent fuel storage facility, without the need to unload the casks and transfer the spent fuel to a separate storage system. However, once in storage, these very expensive dual purpose casks cannot perform additional transport until they have been emptied of their current contents and returned to transport service.

Thus, a heretofore unaddressed need exists in the industry to address the aforementioned deficiencies and inadequacies.

### SUMMARY OF THE INVENTION

Disclosed are methods for transporting and canistering nuclear spent fuel. In one embodiment, the method for transporting and canistering nuclear spent fuel comprises providing a canister that includes a mechanical closure for a canister lid and a container at a first or origin remote facility. The mechanical closure can be a bolted closure, a screwed closure, or any other form of mechanical closure that results in sealing. The canister containing the nuclear spent fuel is loaded into a transport cask without the canister closure and a transport cask is sealed at the first or origin remote facility. The transport cask containing the canister and nuclear spent fuel is transported to a second remote facility. At the second remote facility, the transport cask is opened and the canister lid to the container of the canister is installed using the mechanical closure to seal the canister after the canister is transferred to the second remote facility. The canister containing the spent nuclear fuel is placed into an overpack, which is stored at the remote facility.

As a further option, the canister lid is welded on the container of the canister to seal the canister after the canister is transported to the remote facility.

The invention has numerous advantages, a few of which are delineated hereafter, as merely examples.

An advantage of the invention is that there may be no costly welding or other inspection/testing capital equipment. There is no need for consumable supplies to support the welding operations (weld wire, gases, dye penetrant, etc.).

Another advantage of the invention is that no special location for welding is set aside and no special provisions for shielding, ventilation (HVAC), and utility services must be supplied for canister welding.

Another advantage of the invention is that there will be no need for certified canister closure welders, together with the administration of training, qualification/certification, and welding data/record services programs.

Another advantage of the invention is that the mechanical canister closure takes much less time and personnel cost to seal the canister.

Another advantage of the invention is that the personnel radiation exposure will be commensurately reduced.

Another advantage of the invention is that when the canisters with mechanical closures are reopened, the canisters, along with their lids, can be recycled for use again with other fuel. One of the waste materials will be the lid seals that are replaced and any materials from decontamination of the canisters for reuse. However, these waste volumes are substantially less than those that result from the disposal of the entire canister, should fuel be removed from a canister with a welded closure.

Another advantage of the invention is that in the long term, the canisters may also be incorporated directly into second-generation waste packages, thereby helping to reduce the cost of those packages and reducing the cost of repackaging the spent fuel.

Another advantage of the invention is that for waste aging applications, the method is much more cost effective because the capital cost of storage of such spent fuel in canister-based systems placed in concrete overpacks is only a fraction of the capital cost of the far more expensive dual purpose metal casks. The service of metal casks is best applied to transport of spent fuel, whether as bare fuel or canistered fuel.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a partially cut-away, partially exploded, perspective view of one embodiment of a storage system.

FIG. 2 is a partially cut-away, cross-sectional, side view of one embodiment of the storage system shown in FIG. 1.

FIG. 3 is a partially cut-away, partially cross-sectional, perspective view showing detail of one embodiment of a closure lid shown in FIGS. 1-2.

FIG. 4 is a partially cut-away, cross-sectional, side view showing detail of one embodiment of a closure lid shown in FIGS. 1-2.

FIG. 5 is a partially cut-away, partially cross-sectional, perspective view showing detail of one embodiment of an outer lid shown in FIGS. 1-2.

FIG. 6 is a partially cut-away, cross-sectional, side view of one embodiment of an outer lid shown in FIGS. 1-2.

FIG. 7 is a diagram that illustrates a transport cask on a shipping cradle to transport a canister having a mechanical closure from one location to another.

FIG. 8 is a diagram that illustrates a transfer cask, a canister having a mechanical closure, and an overpack.

FIG. 9 is a flow diagram that illustrates one embodiment of operation of storing and transporting spent nuclear fuel using a canister having a mechanical closure.

FIG. 10 is a flow diagram that shows detail of one embodiment of the step of providing a canister shown in FIG. 9.

FIG. 11 is a flow diagram that shows detail of one embodiment of the step of installing a lid to the container of the canister shown in FIG. 9.

FIG. 12 is a flow diagram that shows detail of one embodiment of the step of placing the canister in the overpack shown in FIG. 9.

### DETAILED DESCRIPTION OF THE PREFERRED EMBODIMENT

Disclosed are methods for a canister that stores and transports spent nuclear fuel. In one embodiment, the method includes providing a canister that includes a mechanical sealed closure (e.g., bolted closure, or screwed closure) for a canister lid and a container to seal the canister. The nuclear spent fuel is loaded into the canister at the power plant. The canister containing the nuclear spent fuel is loaded into a transport cask and the transport cask is sealed at the power plant. It should be noted that the canister lid is not sealed on the container at the power plant. The transport cask containing the canister and nuclear spent fuel is transported to a remote facility. At the remote facility, the transport cask is opened and the lid to the canister is installed using the mechanical closure to seal the canister after the canister is transported from the power plant to the remote facility. The canister containing the spent nuclear fuel is placed into an overpack, which is stored at the remote facility.

Example apparatus, systems, and methods are discussed with reference to the figures. Although the apparatus, systems, and methods are described in detail, they are provided for purposes of illustration only and various modifications are feasible. The exemplary apparatus having a bolted closure as a mechanical closure for a canister lid and container is first discussed. After the exemplary apparatus has been described, examples of systems for storing and transporting spent nuclear fuel are provided, particularly a transport cask, a transfer cask, a transfer adapter and an overpack. After the exemplary systems have been described, examples of methods for storing and transporting spent nuclear fuel are provided.

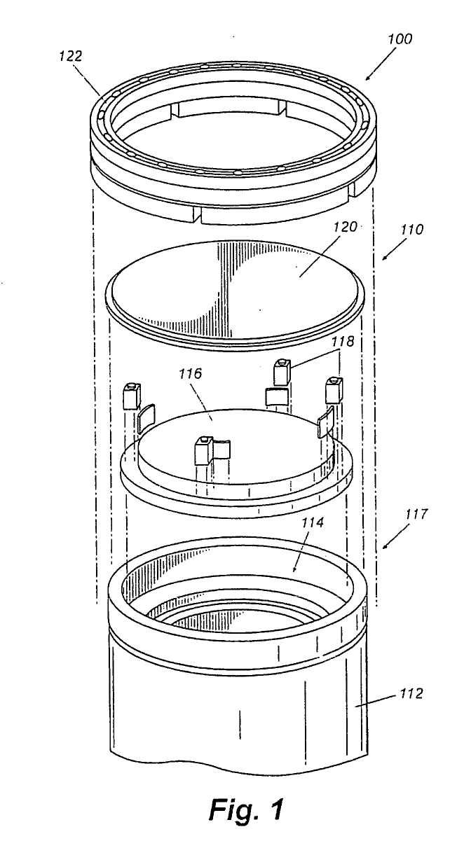

Referring now to FIG. 1, an embodiment of the storage system 100 using a bolted closure will now be described in detail. The storage system 100 is disclosed in U.S. Pat. No. 6,784,443, which is entirely incorporated by reference herein. It should be mentioned that the mechanical closure is preferably the bolted closure. As depicted therein, storage system 100 incorporates a canister 110 which includes an outer wall or shell 112 and a bottom (not shown) that cooperate to define an interior 114 which is suitable for the storage of materials therein. Additionally, a closure lid 116 is adapted to be received within an open end 117 of the canister and forms a seal therewith for containing materials within the interior of the canister. Preferably, one or more compression members or links 118 (described in detail hereinafter) are provided for urging or forcing the closure lid into sealing engagement with the canister.

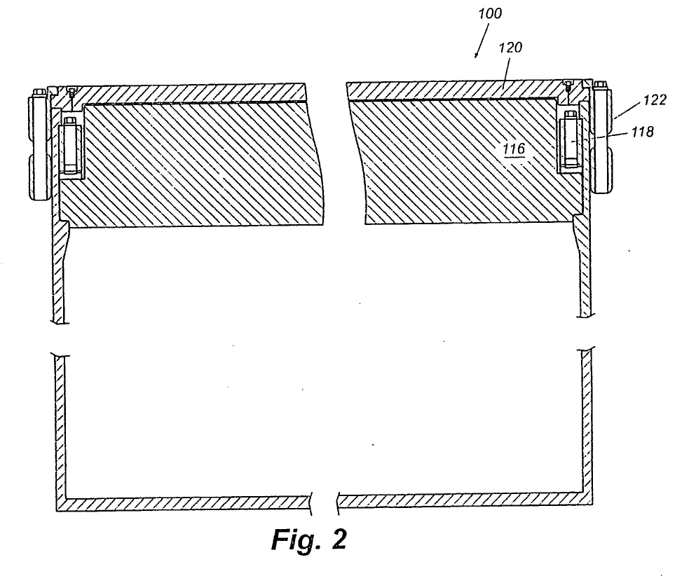

In some embodiments, an outer lid 120 cooperates with an open end 117 of the canister so that a redundant seal of the storage system is provided. Preferably, the outer lid is retained in sealing engagement with the distal end of the canister by a hold-down member 122 (described in detail hereinafter). As depicted in FIG. 2, the canister 110, closure lid 116 and compression links 118, and, in embodiments so provided, outer lid 120 and hold-down member 122, cooperate to provide a non-welded closure system 100. System 100 may, in some embodiments, offer one or more advantages over classical bolted closures which typically require a flanged surface or ledge. Such a ledge typically protrudes beyond the shell of a canister or, in other embodiments, encroaches upon the opening of the canister, in order to provide a significantly strong and sizable surface (flange) to allow bolts, which are adapted to secure the lid to the canister, to be placed therethrough. In regard to bolted closures utilizing flanges that extend beyond the canister shell, such a configuration typically provides access to the full opening of the canister; however, typically only a single lid closure may be utilized. In regard to those embodiments which utilize flanges which encroach upon the opening of the canister, such a configuration tends to preclude the use of outer or peripheral regions of the canister interior.

Referring now to FIG. 2, the embodiment of the closure lid 116 depicted therein is adapted to permit a basket or other suitable structure to receive a material to be stored, such as SNF, for example. A basket for storing SNF, for example, typically comprises vertical and lateral support members which may be combined with neutron absorbers. These features provide structural support to the SNF so that a correct, predetermined geometry of the SNF is maintained under both normal and accident conditions, thereby ensuring that heat transfer and nuclear criticality requirements are maintained. Various configurations of baskets and other material support structures may be utilized to perform the aforementioned functionality as may be required based upon the particular application, with all such configurations considered well within the scope of the present invention.

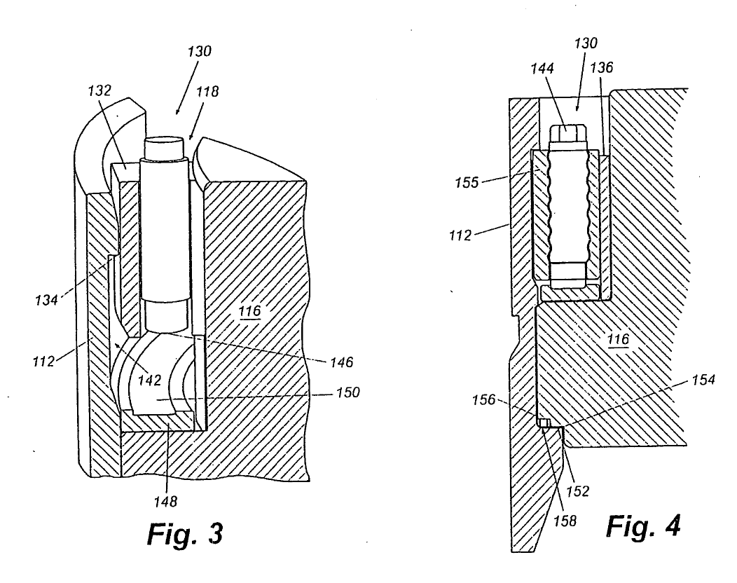

Referring now to FIGS. 3 and 4, closure lid 116 and its associated components will now be described in greater detail. As shown in FIG. 3, closure lid 116 cooperates with canister shell 112 to form an annular space or region 130. Compression links 118 are adapted to be inserted between the canister shell 112 and closure lid 116 within the annular region 130. As shown in greater detail in FIG. 4, once a compression link 118 is inserted within the annular region 130, the compression link preferably is urged radially outwardly so that an upper or engagement surface 132 of the compression link is positioned below a closure lid-retention surface 134 formed in canister shell 112. Preferably, urging of the compression link radially outwardly is facilitated by inserting a backing ring or wedge 136 between a surface of the closure lid and an exterior surface of the compression link, thereby allowing a portion of the compression link to be received within retention recess 142 of the canister shell 112.

Once appropriately positioned with the retention recess, drive bolt 144 of the compression link may be driven so that a distal end 146 of the drive bolt is urged downwardly toward the closure lid. Preferably, although not required, that portion of the closure lid which is intended to receive or engage the distal end 146 of the drive bolt is configured with a hardened surface which is adapted to resist substantial deformation in response to engagement of the drive bolt. In some embodiments, the functionality of the hardened surface may be achieved by one or more bearing members or inserts 148. Such an insert may be formed of metal or any other suitable material.

In some embodiments, insert 148 may include a bolt-receiving recess 150 for properly positioning the distal end 146 of the drive bolt. So provided, once the bolt is driven so that the distal end of the drive bolt engages the insert, downward force of the bolt is transferred to the closure lid, thereby urging a seating surface 152 of the closure lid against a closure lid-receiving ledge 154. Additionally, in reaction to the downward force of the bolt, the outer retaining member 155 of the compression link is urged upwardly so that the engagement surface 132 engages the closure lid-retention surface 134, thereby retaining the closure lid in its locked or sealed position.

In order to facilitate a more secure sealing of the closure lid, some embodiments may incorporate a gasket 156 which is adapted to engage in a sealing relationship with the closure lid and the canister shell, such as by being received within a gasket recess 158 of the closure lid and engaging a surface defining the recess as well as seating surface 152 of the canister shell. So provided, engagement of the compression link with the closure lid and canister shell places axial, tensile force in that portion of the canister shell located between the closure lid-retention surface and the closure lid-receiving ledge, while exerting a compressive force on the closure lid. This is accomplished with the bolts of the compression links not being attached to or through the seating surface of the closure lid or the closure lid-receiving ledge of the canister shell.

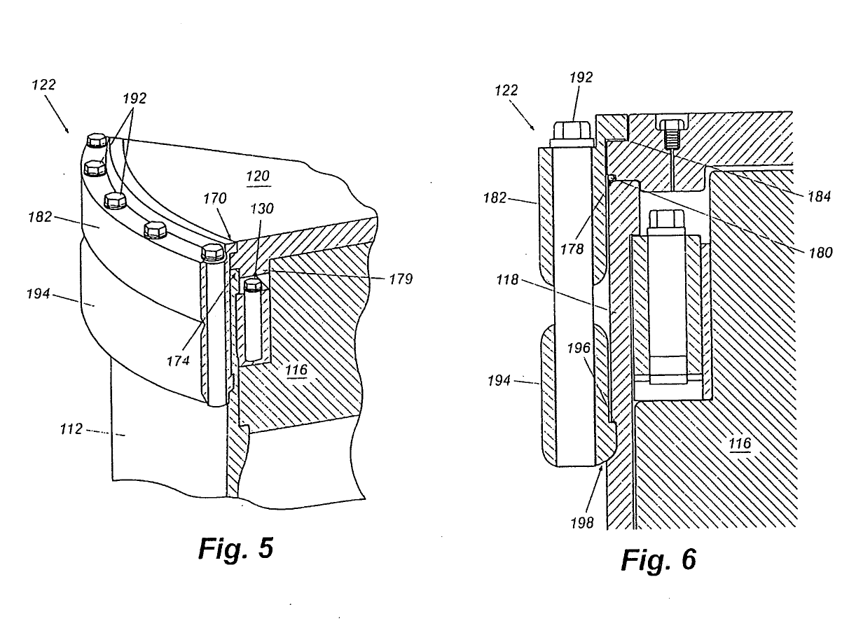

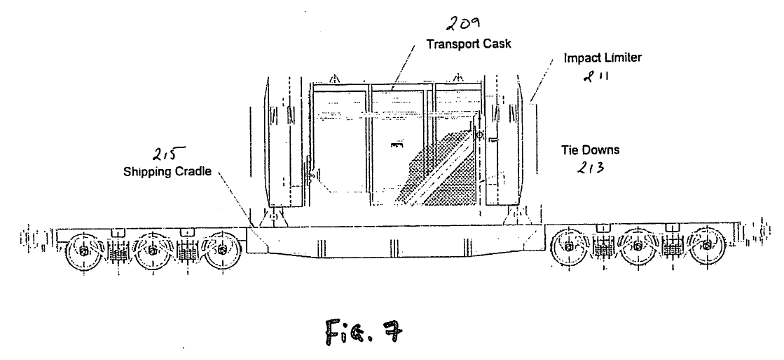

Referring now to FIGS. 5 and 6, outer lid 120 and its associated components will now be described. As shown in FIG. 5, outer lid 120 is adapted to cooperate with canister shell 112 so that closure lid 116 is disposed between the outer lid and the interior of the canister. Although capable of numerous configurations, outer lid 120 preferably incorporates a hold down-receiving recess 170 formed along an upper edge thereof and an opposing seating surface 174 which is adapted to engage a distal end of the canister shell. Seating surface 174 may incorporate a gasket recess 178 which is adapted to receive a gasket 180 for promoting sealing engagement of the outer lid with the canister shell. Additionally, an alignment protrusion 179 may be provided on a underside of the outer lid that is adapted to be received by the annular region 130, so that the outer lid may be appropriately aligned with the closure lid and canister shell.

Preferably, lid hold-down member 122 incorporates an upper ring 182 which is adapted to be received about the distal end of the canister shell and the outer lid, with an outer lid hold-down ledge 184 protruding from an inner surface of the ring. The hold-down ledge 184 is adapted to be received by the hold-down receiving recess 170 of the outer lid. A plurality of connectors 192, e.g., bolts, depend from the ring, with each of the connectors engaging a lid hold-down segment 194. Each lid hold-down segment is configured as an arcuate segment with an inner diameter which is appropriately configured so that each segment may be received about an exterior surface of the canister shell. In order to facilitate sealing engagement of the outer lid with the canister shell, each lid hold-down segment preferably incorporates an outer lid-retaining ledge 196 which extends inwardly from its respective segment. The aforementioned outer lid-retaining ledges are adapted to engage within a compression recess 198 formed in an outer surface of the canister shell. So configured, when the connectors are tightened, each lid hold-down segment is urged toward the ring, thereby causing the outer lid-retaining ledge 196 to engage the compression recess 198 of the canister and the outer lid hold-down ledge 184 of the ring 182 to engage the hold-down receiving recess 170 of the outer lid. Thus, when so tightened, the outer lid is held in compression against the canister shell.

It should be noted that the mechanism closure of the canister can also include a screwed closure as disclosed in U.S. Pat. No. 5,615,794, which is entirely incorporated by reference herein, as well as any other mechanical closure.

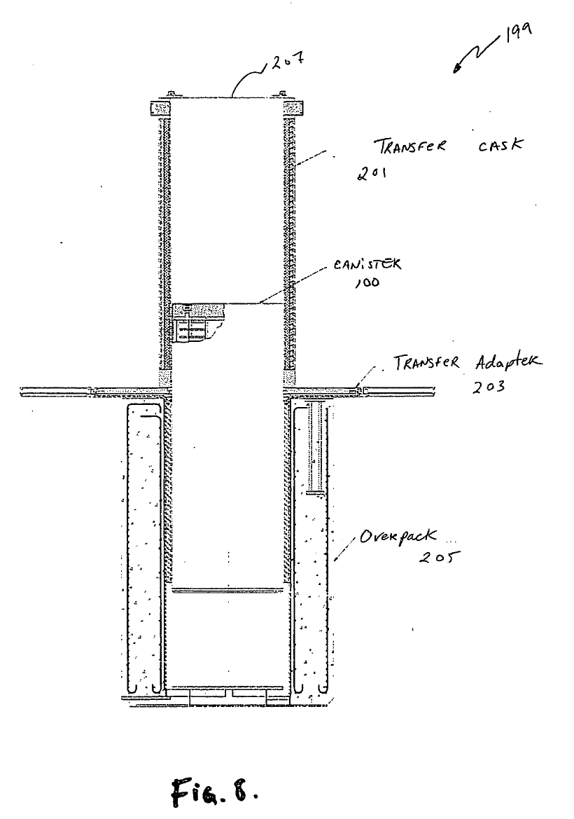

FIG. 7 is a diagram that illustrates a transport cask on a shipping cradle to transport a canister having a mechanical closure from one location to another. The transport cask 209 includes an impact limiter 211 at the ends of the transport cask 209 and tie downs 213 restraining the transport cask 209 to its position on a shipping cradle 215. The tie downs 213 mechanically secures the transport cask 209 to the shipping cradle 215, which transports the canister 100 from a power plant (not shown) to a remote facility (not shown). Preferably, the canister 100 containing spent nuclear fuel is loaded in the transport cask 209 at the power plant and the canister 100 is not sealed with a canister lid using a mechanical closure at the power plant. The transport cask 209 is sealed before the transport cask 201 is transported to the remote facility. When the transport cask 209 arrives at the remote facility, the transport cask 209 is opened and the canister 100 is preferably placed in a transfer cask (shown in FIG. 8) to be transferred into an overpack (shown in FIG. 8).

FIG. 8 is a diagram that illustrates a transfer cask, a canister having a mechanical closure, and an overpack. A transferring system 199 includes a transfer cask 201, a canister 100, a transfer adapter 203, and an overpack 205. The canister 100 is transferred from the transfer cask 201 to an overpack 205 that is predisposed at the remote facility. At the remote facility, the transport cask is opened and the canister 100 is sealed with a canister lid using the mechanical closure, preferably a bolted closure to seal the canister as mentioned above. In an alternative embodiment, the canister lid can be screwed and/or welded to seal the canister lid to the container of the canister. The sealed canister is then transferred to the transfer cask. Preferably, a canister lifting system (not shown) is installed to facilitate transferring the canister 100 from the transfer cask 201 to the overpack 205. The transfer cask 201 containing the canister with the closure lid installed is placed on the transfer adapter 203 that facilitates transferring the canister 100 from the transfer cask 201 to the overpack 205. Preferably, a bottom door of the transfer cask 201 is opened and the canister lifting system lowers the canister 100 from the transfer cask 201 to the overpack 205. The transfer cask 201, transfer adapter 203, and the canister lifting system are removed and the overpack 205 is installed with an overpack lid (not shown). The overpack containing the canister 100 and spent nuclear fuel is moved to a storage location in the remote facility.

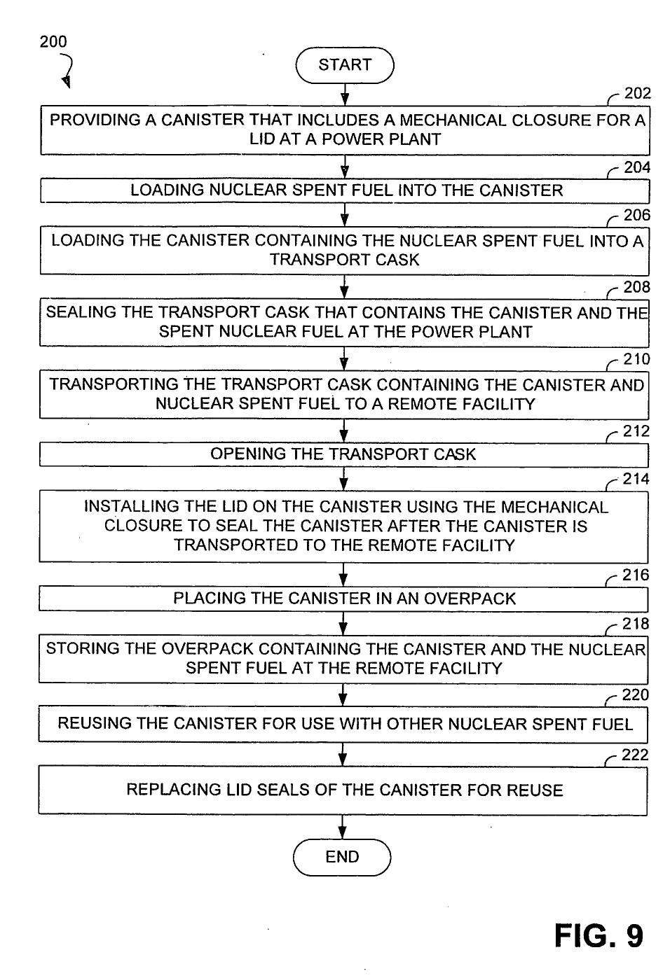

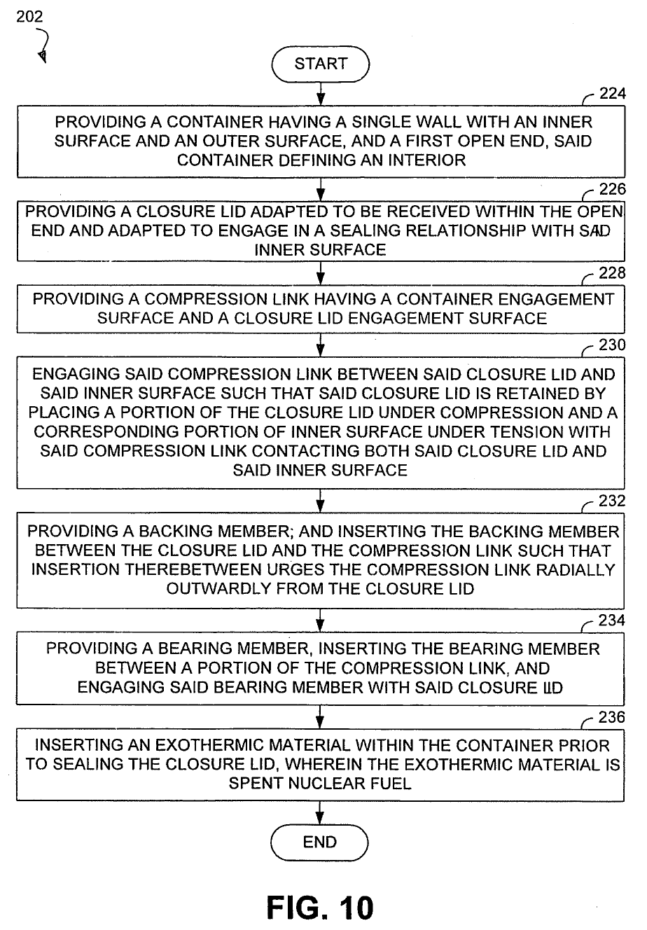

FIG. 9 is a flow diagram that illustrates an embodiment of operation of storing and transporting spent nuclear fuel using a canister having a mechanical closure. The operation 200 begins at a power plant and includes the step of, as shown in block 202, providing a canister that includes a mechanical closure for a canister lid and a container. As mentioned above, the mechanical closure includes a bolted closure ,screwed closure or other mechanical closure. The step for providing the canister as shown in block 202 is further described in relation to FIG. 10. In block 204, the nuclear spent fuel is loaded into the canister and in block 206, the canister containing the nuclear spent fuel is loaded into a transport cask. It is preferred that the lid is not installed on the canister at the power plant. In block 208, the transport cask is sealed at the power plant and in block 210, the transport cask containing the canister and nuclear spent fuel is transported to a remote facility.

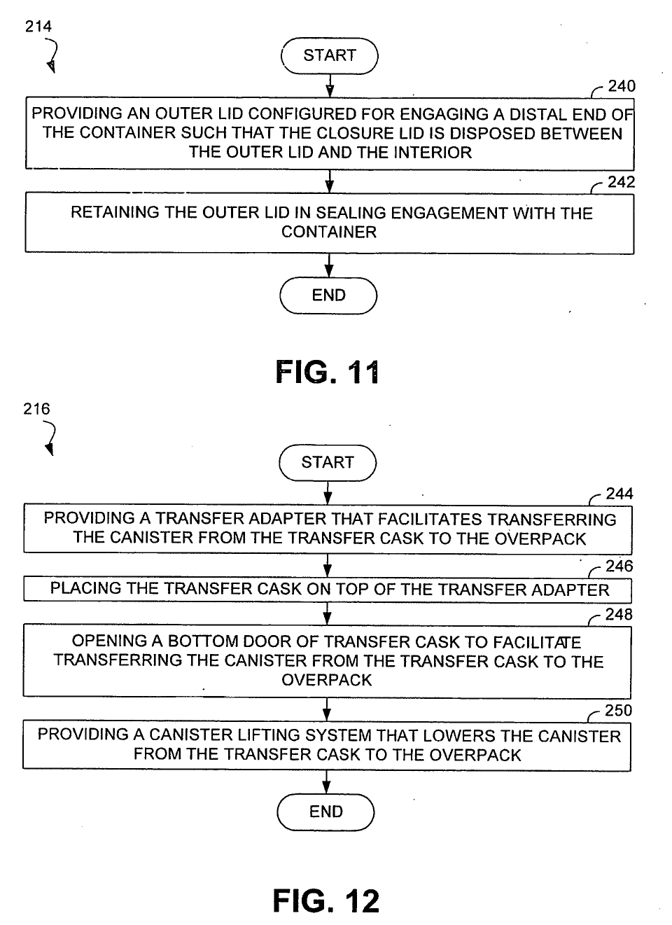

In block 212, the transport cask is opened and in block 214, the canister lid to the container of the canister is installed using the mechanical closure to seal the canister after the canister is transported to the remote facility via the transport cask. The step for installing the canister lid to a canister as shown in block 214 is further described in relation to FIG. 11. In block 216, the canister is placed into a protective, passively cooled overpack and in block 218, the overpack containing the container and the nuclear spent fuel is stored at the remote facility. The step for placing the canister in the overpack as shown in block 216 is further described in relation to FIG. 12. In block 220, the lid of the canister can be uninstalled and removed for unloading the spent nuclear fuel to reuse the canister for storing and transporting other nuclear spent fuel. In block 222, lid seals of the canister are replaced for reuse of the canister.

FIG. 10 is a flow diagram that shows detail of an embodiment of the step 202 of providing a canister shown in FIG. 9. The step 202 of providing a canister further includes, as shown in block 224, providing a container that includes a single wall with an inner surface and an outer surface, and a first open end, which the container defines an interior. In block 226, a closure lid is provided that is adapted to be received within the open end and adapted to engage in a sealing relationship with the inner surface. In block 228, a compression link is provided that includes a container engagement surface and a closure lid engagement surface. In block 230, the compression link is engaged between the closure lid and the inner surface such that the closure lid is retained by placing a portion of the closure lid under compression and a corresponding portion of inner surface under tension with the compression link contacting both the closure lid and the inner surface.

In block 232, a backing member is provided to be inserted between the closure lid and the compression link such that insertion therebetween urges the compression link radially outwardly from the closure lid. In block 234, a bearing member is provided to be inserted between a portion of the compression link and to engage the bearing member with the closure lid. In block 236, an exothermic material is inserted within the container prior to sealing the closure lid, wherein the exothermic material is SNF.

FIG. 11 is a flow diagram that shows detail of an embodiment of the step of installing a canister lid to the container of the canister shown in FIG. 9. The step 214 of installing the canister lid to the container of the canister further includes, as shown in block 240, providing an outer lid configured for engaging a distal end of the container such that the closure lid is disposed between the outer lid and the interior, and retaining the outer lid in sealing engagement with the container, as shown in block canister to seal the canister after the canister is transferred to the remote facility. As a further option, the canister lid is screwed, welded, or otherwise sealed on the container of the canister after the canister is transferred to the remote facility.

FIG. 12 is a flow diagram that shows detail of an embodiment of the step of placing the canister in the overpack shown in FIG. 9. The step 216 of placing the canister in the overpack further includes, as shown in block 244, providing a transfer adapter that facilitates transferring the canister from the transfer cask to the overpack. In block 246, the transfer cask is placed on top of the transfer adapter. In block 248, a bottom door of the transfer cask is opened to facilitate transferring the canister from the transfer cask to the overpack. In block 250, a canister lifting system is provided to lower the canister from the transfer cask to the overpack.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

Therefore, having thus described the invention, at least the following is claimed:

1. A method for transporting and canistering nuclear spent fuel, the method comprising:
providing a canister that includes a mechanical closure for a canister lid and a container at a first remote facility;
loading nuclear spent fuel into the canister;
loading the canister containing the nuclear spent fuel into a transport cask;
transporting the transport cask containing the canister and nuclear spent fuel to a second remote facility;
installing the canister lid on the canister using the mechanical closure to seal the canister after the canister is transferred to the second remote facility;
placing the canister in an overpack; and
storing the overpack containing the container and the nuclear spent fuel at the second remote facility.

2. The method of claim 1, further comprising sealing the transport cask containing the canister along with the spent nuclear fuel at the first remote facility.

3. The method of claim 2, further comprising opening the transport cask at the second remote facility.

4. The method of claim 3, further comprising installing the canister lid on the container of the canister using the mechanical closure after opening the transport cask.

5. The method of claim 1, wherein placing the canister in the overpack comprises:
placing the canister in a transfer cask;
providing a transfer adapter that facilitates transferring the canister from the transfer cask to the overpack; and
placing the transfer cask on top of the transfer adapter.

6. The method of claim 5, wherein placing the canister in the overpack further comprises opening the transfer cask to facilitate transferring the canister from the transfer cask to the overpack.

7. The method of claim 6, wherein opening the transfer cask comprises opening a bottom door of the transfer cask.

8. The method of claim 7, wherein placing the canister in the overpack comprises providing a canister lifting system that lowers the canister from the transfer cask to the overpack.

9. The method of claim 1, wherein providing the canister further comprises:
providing a container having a single wall with an inner surface and an outer surface, and a first open end, said container defining an interior;
providing a closure lid adapted to be received within the open end and adapted to engage in a sealing relationship with said inner surface;
providing a compression link having a container engagement surface and a closure lid engagement surface;
engaging said compression link between said closure lid and said inner surface such that said closure lid is retained by placing a portion of the closure lid under compression and a corresponding portion of inner surface under tension with said compression link contacting both said closure lid and said inner surface.

10. The method of claim 9, wherein providing the canister further comprises:
providing a backing member; and
inserting the backing member between the closure lid and the compression link such that insertion therebetween urges the compression link radially outwardly from the closure lid.

11. The method of claim 9, wherein providing the canister further comprises:
providing a bearing member;
inserting the bearing member between a portion of the compression link; and
engaging said bearing member with said closure lid.

12. The method of claim 9, wherein installing the lid on the canister to seal the canister further comprises:
providing an outer lid configured for engaging a distal end of the container such that the closure lid is disposed between the outer lid and the interior;
retaining the outer lid in sealing engagement with the container.

13. The method of claim 12, wherein installing the outer lid on the canister comprises bolting the outer lid on the canister to seal the canister after the canister is transported to the second remote facility.

14. The method of claim 12, wherein installing the outer lid on the canister comprises screwing or welding the lid on the canister to seal the canister after the canister is transported to the second remote facility.

15. The method of claim 1, further comprising reusing the canister for use with other nuclear spent fuel.

16. The method of claim 1, further comprising inserting an exothermic material within the container prior to sealing the closure lid.

17. The method of claim 16, wherein the exothermic material is spent nuclear fuel.
